(19) United States
(12) Patent Application Publication
(10) Pub. No.: US 2014/0216139 A1
(43) Pub. Date: Aug. 7, 2014

(54) TEST APPARATUS FOR RECHARGEABLE BATTERY

(71) Applicant: JUSUN INSTRUMENTS CO., LTD., NEW TAIPEI CITY (TW)

(72) Inventor: JONATHAN YANG, NEW TAIPEI CITY (TW)

(73) Assignee: JUSUN INSTRUMENTS CO., LTD., NEW TAIPEI CITY (TW)

(21) Appl. No.: 13/798,867

(22) Filed: Mar. 13, 2013

(30) Foreign Application Priority Data
Feb. 1, 2013 (TW) 102202275

(51) Int. Cl. G01M 3/02

(52) U.S. Cl. CPC G01M 3/02
USPC 73/49.3

(57) ABSTRACT

A test apparatus is provided for detecting a gas leakage from at least a rechargeable battery, the test apparatus includes a stainless steel vacuum chamber storing the rechargeable battery and full of the low temperature gases, a first pump coupled to the stainless steel vacuum chamber and sucking the low temperature gases in the stainless steel vacuum chamber so the pressure inside is decreased to a first pressure, a second pump coupled to the stainless steel vacuum chamber, wherein after the pressure inside the stainless steel vacuum chamber is decreased to the first pressure, the second pump sucks the low temperature gas in the stainless steel vacuum chamber so the pressure inside is decreased from the first pressure to a second pressure, and a test device coupled to the second pump and tests the gas leaked from the rechargeable battery among the low temperature gas.

This application claims the benefits of the Taiwan Patent Application Serial NO. 102202275 filed on Feb. 1, 2013, the subject matter of which is incorporated herein by reference.

### BACKGROUND OF THE INVENTION

1. Field of the Invention

The present invention relates to a test apparatus for rechargeable battery and more particularly, relates to a test apparatus with two pumps to perform a two-stage extraction on a stainless steel vacuum chamber so as to test a gas leakage from a rechargeable battery.

2. Description

The development of science and technology has made cell phones, PDAs, tablet computers and notebook computers popular in people's life. All of these electronic devices require rechargeable batteries for which can be utilized repeatedly. At present, there are various types of rechargeable batteries; for example, Ni—Cd battery, Ni—Mh battery, Li-ion battery, Li-polymer battery, etc. Among these types, Li-ion battery (hereafter: Li-battery) is the main stream in the market, especially cell phones, due to its advantages of long durability of cycles, free from memory effect, high energy density and small size.

Generally speaking, basic component elements of battery are positive electrode, negative electrode and electrolyte; Li-battery consists lithium alloy oxide of positive electrode, liquid organic electrolyte and carbon material of negative electrode; the average working voltage of Li-battery is 3.6V, which equals to the voltage of 3 Ni—Cd batteries in series or 3 Ni—Mh batteries in series. Besides, a separation membrane is disposed to separate the positive electrode from the negative electrode in order to avoid a short circuit; organic electrolyte is included in plastic separation membrane having multiple holes and transmits ion charges. When charging, electrons go from outside the charger to carbon material of negative electrode; meanwhile, lithium ions of positive electrode leave the positive electrode and enter negative electrode via electrolyte. When discharging, electrons and lithium ions move toward contrary directions.

When manufacturing Li-batteries for cell phones, absorbing components are disposed inside battery case; positive electrode plate and negative electrode plate are connected in inner side surface of cover and case respectively; cover is utilized to cover the opening in the upper end of the case; around the cover and the opening of the case are sealed with welding technique; electrolyte is injected into the case via a pre-set hole on the cover, the pre-set hole is then sealed. To avoid dangers (e.g. explosion occurred when a large amount of gasses are leaked due to high temperature for overtime usage) generated when Li-battery having a gas leak, usually there is a safe and security protocol for testing, in which Li-battery is put inside a stainless steel chamber and the pressure inside the chamber is only reduced to a certain value once. As a result, under the situation of uneven disturbance, the test result is not precise and complete. Thus, present test apparatus still needs to be improved.

### SUMMARY OF THE INVENTION

In prior art, Li-battery is put inside a stainless steel chamber and the pressure inside the chamber is only reduced to a certain value once. As a result, under the situation of uneven disturbance, the test result is not precise and complete.

Therefore, a test apparatus is provided for detecting a gas leakage from at least a rechargeable battery, the test apparatus includes a stainless steel vacuum chamber, a first pump, a second pump and a test device. The stainless steel vacuum chamber stores the rechargeable battery and is full of the low temperature gases. The first pump is coupled to the stainless steel vacuum chamber and sucks the low temperature gases in the stainless steel vacuum chamber so the pressure inside the stainless steel vacuum chamber is decreased to a first pressure. The second pump is coupled to the stainless steel vacuum chamber; after the pressure inside the stainless steel vacuum chamber is decreased to the first pressure, the second pump sucks the low temperature gas in the stainless steel vacuum chamber so the pressure inside the stainless steel vacuum chamber is decreased from the first pressure to a second pressure. The test device is coupled to the second pump and tests the gas leaked from the rechargeable battery among the low temperature gas.

Therefore, since the test apparatus of the present invention performs a two-stage extraction on the stainless steel vacuum chamber, gases inside the stainless steel vacuum chamber are well disturbed in the second extraction and thus can be extracted evenly and efficiently;

as a result, the accuracy of test is improved and the user experience of rechargeable batteries is upgraded.

Besides, according to an embodiment of the present invention, the test apparatus further includes a low temperature gas generation device and a filter. The filter is coupled to the stainless steel vacuum chamber and filters the low temperature gases. The low temperature gas generation device is coupled to the filter for providing the low temperature gas. The stainless steel vacuum chamber is installed with a plurality of pipelines coupled to the first pump and the second pump, and a plurality of air holes are installed on the pipelines.

The first pressure is selected from the group from −65 Kpa to −70 Kpa and the second pressure is selected from the group from −85 Kpa to −90 Kpa. According to an embodiment of the present invention, the first pressure is −70 Kpa and the second pressure is −90 Kpa. Besides, the test apparatus further includes a first gas valve and a second gas valve, the first gas vales coupled to the stainless steel vacuum chamber and the first pump, the first gas vales controlling and switching the first pump, the second gas vales coupled to the stainless steel vacuum chamber and the second pump, the second gas vales controlling and switching the second pump.

The test device is selected from the group of photo ionization detector, reducer gas analyzer, and electronic nose. The test apparatus further includes a programmable logic controller electrically connected to the test device and controlling the test device. The first pump and the second pump include a vacuum pump and the rechargeable battery includes a Li-battery.

### BRIEF DESCRIPTION OF THE DRAWINGS

Other features and advantages of this invention will become more apparent in the following detailed description of the preferred embodiments of this invention, with reference to the accompanying drawings.

FIG. 1 is a schematic view showing a test apparatus for rechargeable battery according to an embodiment of the present invention.

FIG. 2 is a breakdown drawing showing a stainless steel vacuum chamber according to an embodiment of the present invention.

### DETAILED DESCRIPTION OF THE PREFERRED EMBODIMENT

The present invention relates to a test apparatus for rechargeable battery. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

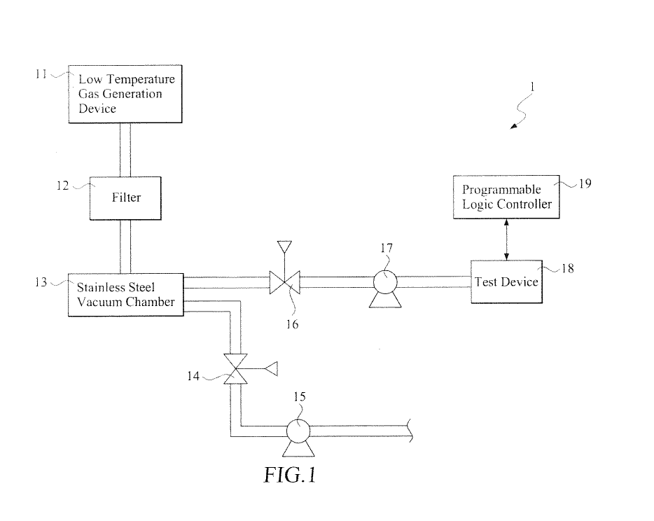

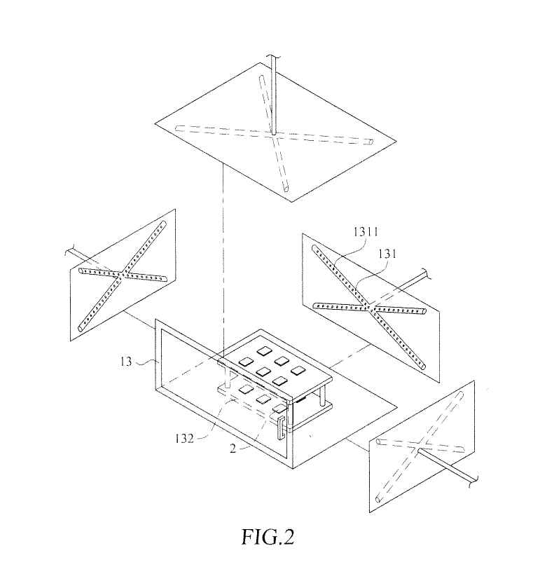

Refer to FIG. 1 and FIG. 2; FIG. 1 is a schematic view showing a test apparatus for rechargeable battery according to an embodiment of the present invention; FIG. 2 is a breakdown drawing showing a stainless steel vacuum chamber according to an embodiment of the present invention. A test apparatus 1 is provided for detecting a gas leakage from at least a rechargeable battery 2.

According to an embodiment of the present invention, the rechargeable battery 2 is a Li-battery. The test apparatus 1 includes a low temperature gas generation device 11, a filter 12, a stainless steel vacuum chamber 13, a first gas valve 14, a first pump 15, a second gas valve 16, a second pump 17, a test device 18 and a programmable logic controller (PLC) 19.

The low temperature gas generation device 11 is for example a device that generates gases and cooling down the gases. According to an embodiment of the present invention, the temperature of the low temperature gas is −40° C. The reasons to utilize low temperature gasses according to an embodiment of the present invention are dehumidification, to decrease the incidence of chemical reaction and to lower the action activity so as to improve the performance of the test apparatus 1.

The filter 12 is coupled to the low temperature gas generation device 11; the filter 12 filters and purifies said low temperature gases. The filter 12 can be installed integrally with the low temperature gas generation device 11 in an embodiment of an air filter but is not limited hereof. The stainless steel vacuum chamber 13 is coupled to the filter 12, stores the rechargeable battery 2 and is full of the low temperature gases. The environment inside the stainless steel vacuum chamber 13 is pollution free and evacuated. Besides, a plurality of pipelines 131 and a holder 132 are installed in the stainless steel vacuum chamber 13. According to an embodiment of the present invention, the test apparatus 1 includes four groups of pipelines 131 respectively installed on the right, left, rear and upper side of the stainless steel vacuum chamber 13; the pipelines 131 are installed crosswise so as to be distributed evenly in the stainless steel vacuum chamber 13. The pipelines 131 are installed with a plurality of air holes 1311. Every pipeline 131 is connected to outside with a transportation pipe (not shown). The holder 132 is for holding the rechargeable battery 2.

The first gas valve 14 is coupled to the stainless steel vacuum chamber 13. The first pump 15 is coupled to the stainless steel vacuum chamber 13 via the first gas valve 14 and is coupled to the pipelines 131 via said transportation pipe so as to suck the low temperature gases in the stainless steel vacuum chamber 13 via the air holes 1311 of the pipelines 131. The first pump 15 is a vacuum pump according to an embodiment of the present invention.

The second gas valve 16 is coupled to the stainless steel vacuum chamber 13. The second pump 17 is coupled to the stainless steel vacuum chamber 13 via the second gas valve 16 and is coupled to the pipelines 131 via said transportation pipe so as to suck the low temperature gases in the stainless steel vacuum chamber 13 via the air holes 1311 of the pipelines 131. The second pump 17 is a vacuum pump according to an embodiment of the present invention. The test device 18 is coupled to the second pump 17 for testing the gas leaked from the rechargeable battery 2 among the low temperature gases. The test device 18 is selected from the group of photo ionization detector (PID), reducer gas analyzer (RGA), and electronic nose.

The programmable logic controller (PLC) 19 is electrically connected to the test device 18 to control the test device 18. According to an embodiment of the present invention, the programmable logic controller 19 sets up test parameters of the test device 18; the test parameters include standby time, test threshold value or other test states. In other embodiments of the present invention, the programmable logic controller 19 can be replaced by other processors such as micro-processor, micro-controller, sequencer, digital signal processor or finite-state machine with hardware circuit implementation. Besides, the test apparatus 1 further includes a storage device (not shown) for storing predetermined test parameters, the storage device includes non-volatile memory, magnetic storage device (e.g. hard disk, soft disk, tape, magnetic core memory or magnetic bubble memory) or volatile memory (e.g. DRAM, SRAM).

When a user wants to test the rechargeable battery 2 with the test apparatus 1, the user firstly puts the rechargeable battery 2 in the holder 132 and opens the first gas valve 14 so that the first pump 15 reduces the pressure inside the stainless steel vacuum chamber 13 to a first pressure which is between −65 Kpa to −70 Kpa. According to an embodiment of the present invention, the first pressure is set to be −70 Kpa. After the pressure inside the stainless steel vacuum chamber 13 is reduced to the first pressure, the user closes the first gas valve 14 and waits for a period of time, and then opens the second gas valve 16 so that the second pump 17 reduces the first pressure to a second pressure which is between −85 Kpa to −95 Kpa. According to an embodiment of the present invention, the first pressure is set to be −90 Kpa. Since the inside of the stainless steel vacuum chamber 13 is disturbed during the pressure is reduced to the second pressure, the fluidity of the low temperature gases in increased.

In conclusion, since the test apparatus 1 of the present invention performs a two-stage extraction on the stainless steel vacuum chamber 13, gases inside the stainless steel vacuum chamber 13 are well disturbed in the second extraction and thus can be extracted evenly and efficiently; as a result, the accuracy of test is improved and the user experience of rechargeable batteries is upgraded; so as the industrial applicability.

While the present invention has been particularly shown and described with reference to a preferred embodiment, it will be understood by those skilled in the art that various changes in form and detail may be without departing from the spirit and scope of the present invention.

What is claimed is:

1. A test apparatus for rechargeable battery, the test apparatus detecting a gas leakage from at least a rechargeable battery, the test apparatus comprising:
a stainless steel vacuum chamber, storing the rechargeable battery, the stainless steel vacuum chamber full of at least a low temperature gas;
a first pump coupled to the stainless steel vacuum chamber, the first pump sucking the low temperature gas in the stainless steel vacuum chamber so the pressure inside the stainless steel vacuum chamber is decreased to a first pressure;
a second pump coupled to the stainless steel vacuum chamber, after the pressure inside the stainless steel vacuum chamber being decreased to the first pressure, the second pump sucking the low temperature gas in the stainless steel vacuum chamber so the pressure inside the stainless steel vacuum chamber is decreased from the first pressure to a second pressure; and
a test device coupled to the second pump, the test device testing the gas leaked from the rechargeable battery among the low temperature gas.

2. The test apparatus according to claim 1, further comprising a filter coupled to the stainless steel vacuum chamber, the filter filtering the low temperature gas.

3. The test apparatus according to claim 2, wherein the stainless steel vacuum chamber is installed with a plurality of pipelines coupled to the first pump and the second pump, and a plurality of air holes are installed on the pipelines.

4. The test apparatus according to claim 2, further comprising a low temperature gas generation device coupled to the filter, the low temperature gas generation device providing the low temperature gas.

5. The test apparatus according to claim 1, wherein the first pressure is selected from the group from −65 Kpa to −70 Kpa and the second pressure is −90 Kpa.

6. The test apparatus according to claim 1, further comprising a first gas valve and a second gas valve, the first gas vales coupled to the stainless steel vacuum chamber and the first pump, the first gas vales controlling and switching the first pump, the second gas vales coupled to the stainless steel vacuum chamber and the second pump, the second gas vales controlling and switching the second pump.

7. The test apparatus according to claim 1, wherein the test device is selected from the group of photo ionization detector, reducer gas analyzer, and electronic nose.

8. The test apparatus according to claim 1, further comprising a programmable logic controller electrically connected to the test device and controlling the test device.

9. The test apparatus according to claim 1, wherein the first pump and the second pump include a vacuum pump and the rechargeable battery includes a Li-battery.
